(19) United States
(12) Patent Application Publication
(10) Pub. No.: US 2004/0088212 A1
(43) Pub. Date: May 6, 2004

(54) Dynamic audience analysis for computer content

(76) Inventor: Clarke R. Hill, Portland, OR (US)

Correspondence Address: IPSOLON LLP, 805 SW BROADWAY, #2740, PORTLAND, OR, 97205, US

(21) Appl. No.: 10/385,989

(22) Filed: Mar. 10, 2003

Related U.S. Application Data
(60) Provisional application No. 60/423,333, filed on Oct. 31, 2002.

(51) Int. Cl. G06F 17/60

(52) U.S. Cl. 705/10

(57) ABSTRACT

An online audience measurement system provides analysis of the composition, size and behavior of an online audience. The invention can enable monitoring and analysis of audience characteristics and behavior for content displayed by a computer system. The invention allows the linking of audience profile information, such as demographic characteristics to audience behavior and content preferences. The invention allows the creation of a statistically accurate sample of virtually any computer content audience and can report on the attractiveness of various content offerings to specific audience groups over time, providing a dynamic view of the use of a content site.

### FIELD OF THE INVENTION

The present invention relates to measuring audience traffic of computer content delivered over a computer network and, in particular, to providing statistically valid measurement of audience characteristics for each page of such content.

### BACKGROUND AND SUMMARY OF THE INVENTION

The development of the Internet and the World Wide Web, and the sharing of content through “web” pages and sites, have created a tremendous demand by content creators and content distributors for tools to measure and assess the users of web sites. Many sites are supported by the inclusion of advertising on or linked from the web pages As a result, it is important and valuable to be able to accurately report on the size of the audience that views a page, or advertisement, as well as the demographic composition of the viewing audience. These measurements directly determine the value of the advertising opportunity sold by the content owner or distributor.

For example, the value of television and radio advertising has historically been based on audience reports that are obtained from statistical measurements of each program's audience. These measurements are derived from groups of viewers or listeners of television or radio programming recruited to be a statistically accurate sub-set representative of the program's audience. The most famous sampled measurements for programming are the Nielson ratings provided by Nielsen Media Research, Inc. and the Arbitron ratings provided by the Arbitron Company.

These reports give advertisers important demographic information such as the audience composition in various age, gender, and geographical groups. This is important because advertising inventory is more valuable to an individual advertiser if the demographic composition of the audience more closely matches the advertiser's target customer. Hence, statistically valid audience composition reports directly lead to more efficient use of advertising inventory and higher revenues for advertising-supported content providers. In addition, higher-level demographic data such as income, education, and ethnic background are also very valuable, and provide similar incremental benefits to valuing advertising inventory. Lastly, other audience data such as psychographic or intent-to-buy data (i.e., what proportion of the audience intends to purchase a specific product within a specific time period) is often collected, and offers similar benefits.

Advertising-supported businesses also require one other critical component to the audience reporting. The audience data and reports need to be collected and verified by a trustworthy third-party. Due to the sales relationship between a potential advertiser and the seller of the advertising inventory, data derived solely through self-measurement is inherently suspect and less valuable due to the potential for bias. For an advertising-supported business to prosper, it is important that buyers and sellers adopt standardized data derived from the same methodology so that different sites are accurately comparable.

Even if a web site is not advertising-supported, the site owners frequently want to know more information about the viewers of the site content to gauge its effectiveness and attractiveness. Many web sites are marketing tools for the site owner such as, for example Ford.com, where the Ford Motor Company provides informative content on Ford products to customers and potential customers. It is thus important for Ford to understand the demographic composition of the audience attracted to the site, as well as for sub-sections of the site (e.g., trucks, or individual car models). This information allows Ford to measure how its site is reaching the target audience and to better understand which types of customers are attracted to each product.

Currently many web sites use one of two similar types of site analytics tools to report on audience behavior; log analysis or page tagging. Log analysis works by analyzing data within log files produced by site servers. The data are typically text files that record pages viewed by each visitor. Page tagging is a method of encoding web pages with code or hidden images that establish a network connection to a measurement server once the web page is loaded into a web browser. This is a very accurate method to record each time a viewer has loaded a page from the site into his browser.

Unique visitors can be identified by creating a “cookie”, a term that refers to a small text file that is stored by the visitor's browser, and linked to a specific server (e.g., a measurement server). Each cookie can include data specific to that visitor and can be used to store data about prior visits that can be retrieved when the user makes visits to pages that are linked to the measurement server.

The problem with these approaches is that they do not provide the rich audience view that is necessary for effective site advertising and marketing. The only data provided on the audience are a count of unique browsers accessing the site and a count of the pages they viewed. There is no statistically valid information on audience age, gender, or other demographic, or psychographic data available from the raw browser data.

One approach existing providers have used to offer access to these sources of data is to combine existing site databases, such as visitor registration databases, or customer sales databases, with visitor behavior recorded from site analytics products. These data sources often have the necessary demographic data, but can't serve as representative samples of a site's total audience. Specifically, sales data is only representative of visitors who completed purchases. Registration data is only representative of visitors who registered. And if visitors are forced to register, a high percentage typically provide false answers.

Finally, for use as a currency for brokering the sale of advertising inventory between site owners and advertisers, both data sets are inherently suspect as being self-reported data and lacking comparability across multiple sites due to different collection methodologies. For example, when using registration data, different sites may use different techniques to validate or verify visitor responses, and in some cases they may do no validation or verification at all.

In accordance with the present invention, an online audience measurement system provides statistically valid audience composition and behavior reports for web sites in a format that is usable for third party validation of advertising opportunities for web site advertisers. This invention can allow third parties to collect and validate all measurements, and to use a standard set of data collection methodologies to provide comparable and statistically accurate reports on multiple web site audiences for Internet advertisers. Also, this invention allows statistically valid analysis of visitor characteristics, including demographic, and psychographic information as well as custom, site specific queries.

In one implementation, the method includes tagging targeted web pages with invisible images that are linked to a central measurement server. As each page is loaded into a visitor's browser, a network connection established is established with the central measurement server and allows each browser to be uniquely identified by placement of a cookie associated with the central measurement server, including a unique identifier or ID generated by the central server. This provides for accurate measurement of each page view, and each unique browser, in the page's audience.

To provide demographic data, some or all of the pages that are tagged include additional scripting code that invokes a survey window to survey a visitor for demographic data. To ensure that the results of this survey are statistically representative of the entire page audience, the central measurement server can randomly select which visitors receive the survey. The survey can be used to ask any demographic, psychographic or custom question of interest to the site owner. Because the survey is voluntary, the responses by the selected visitors will typically be more truthful than in a forced environment.

Once a statistically valid sample of the page's audience has been recruited, the central measurement server creates an active panel of site participants and can provide a composition report on the audience. Through the use of the identifying cookie the central measurement server can also track panel participants usage of any other site tagged for such measurement. Through this mechanism, reports on audience behavior can be generated showing how different demographic groups use the web site.

To ensure the sample is as representative as possible, it is important to ensure that visitors who were not selected do not have an opportunity to participate in the survey and that as large a percentage as possible of visitors selected for the surveyanswer the survey questions. The central measurement server's unique identification of each visitor allows the invention to ensure that repeat visitors who were not selected will not be selected in the future simply by returning. This mechanism also offers the opportunity to re-display the survey to repeat visitors who though selected did not complete the survey on prior visits to increase the response rate. In addition, the central measurement server can also increase response rates by offering various inducements to non-responsive selectees on future visits. These methods help ensure that the surveying process produces panels that are highly representative of the target page's audience.

An audience sample recruited as described above can directly provide a representative sample of a web page's or web site's audience. By tracking all visitors, and surveyees, across all measured sites, this invention provides the ability to provide integrated reports on global visitor behavior and demographics. The invention also allows segmenting of audiences into groups based on their responses to the survey questions. The invention allows the tracking of these segment groups across single or multiple sites, including disparate sites owned by separate companies, thereby producing reports to identify the site pages that are most popular with different segments of the audience and to identify the most common paths (i.e., ordered groups of pages) taken by specific audience segments.

Additional objects and advantages of the present invention will be apparent from the detailed description of the preferred embodiment thereof, which proceeds with reference to the accompanying drawings.

### BRIEF DESCRIPTION OF THE DRAWINGS

FIG. 1 is a is a diagrammatic system overview, including data flow, illustrating the measurement of audience access to digital content over a network according to the present invention.

FIG. 2 is a detailed flow chart describing the recruitment method employed in the present invention.

### DESCRIPTION OF THE PREFERRED EMBODIMENT

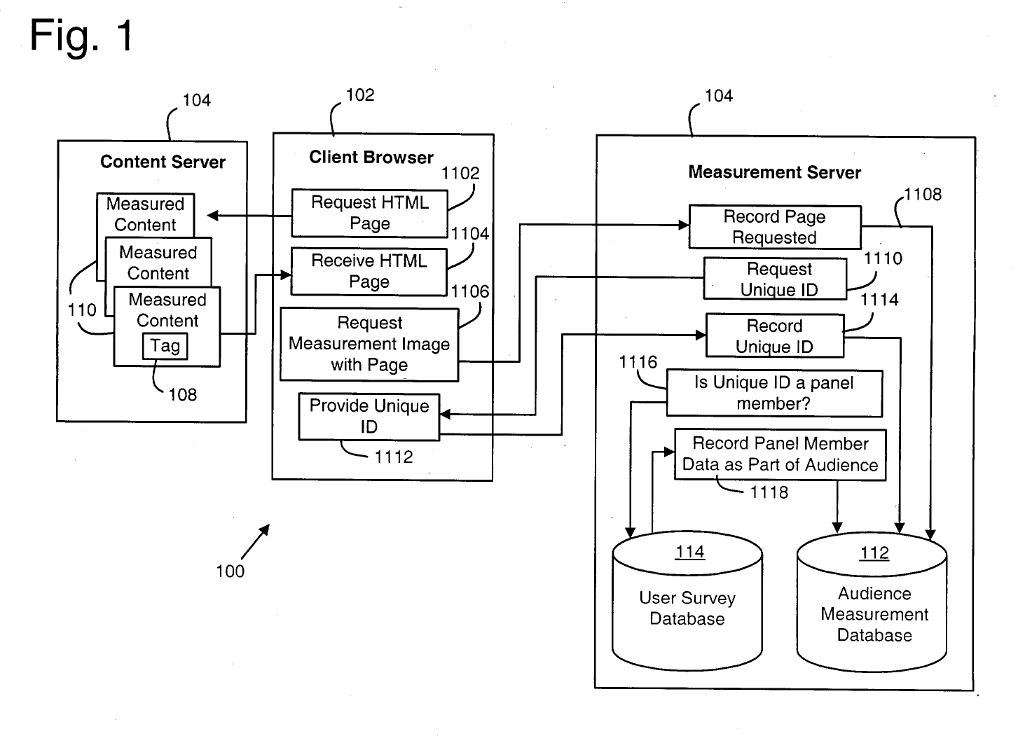

The present invention is directed to a system and method for monitoring user interaction with web services on the Internet. With reference to FIG. 1, an example of such web services includes files accessed with a client browser 102 via the address of an Internet content server 104. For example, a client browser makes a request 1102 for an HTML page and receives the HTML page 1104 from server 104. Through the following description these web files will commonly be referred to as web pages or web resources. The web address will commonly be referred to as a URL. The resource can be a HTML page or any other file supported on the Internet.

A web site is a collection of web files. A web server is software executing on a computer that provides remote access to these files. A client browser is software executing on a user's computer that requests access to the files and displays them for the user.

In accordance with the present invention, access to the web file on content server 104 is monitored by including measurement code 108 in the web file to create measured content 110. This code is often called tags, and tags can include an image reference, JavaScript, Java or code written in any other Internet language. Once loaded in the user browser 102, the tag can be executed, thereby causing a request 1106 to be made to a separate measurement server 106 to create a notification that the content has been loaded by a user or viewer (i.e., client browser 102). This allows the measurement server 106 to count 1108 total accesses to any measured content 110 in an audience measurement database 112.

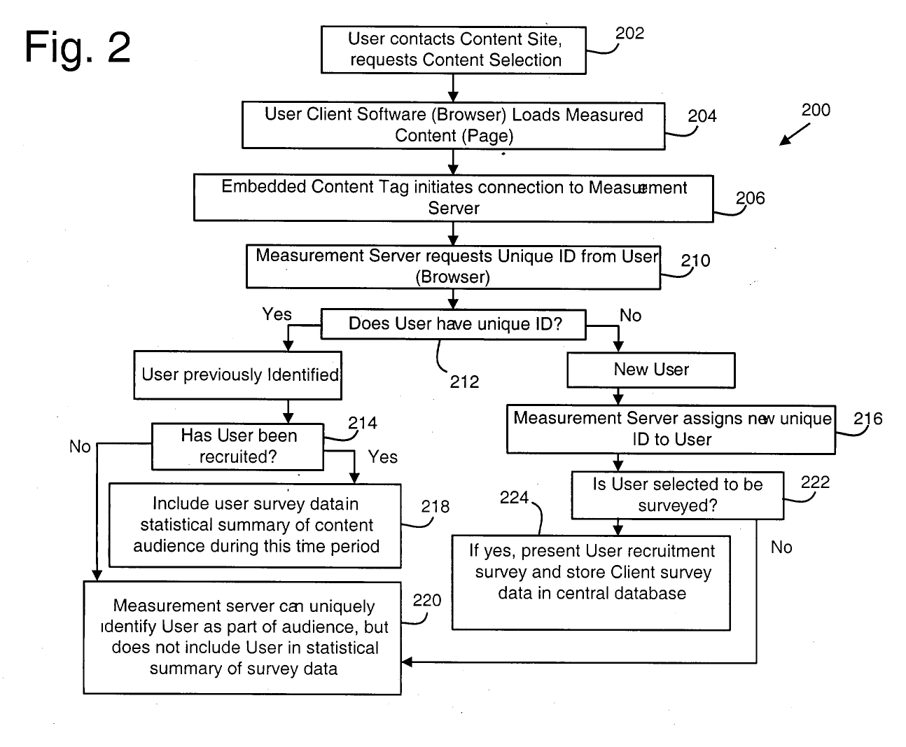

The measurement server 106 will then send a request 1110 to the client browser 102 for information that can uniquely identify the browser. Typically this information is stored in a “cookie”, a small text file stored by the client browser 102 on the client computer and associated with the requesting measurement server 106. If the cookie does not exist, it serves as evidence to the measurement server 106 that the browser 102 has not previously been identified, and the measurement server 106 requests that the client browser 102 create an associated cookie and provides a unique identifier 1112 to be stored in the cookie and records 1114 the unique identifier in the audience measurement database 112. This allows the measurement server 106 to count total unique audience for the web resource. The operation of blocks 1116 and 1118 is illustrated in greater detail below with reference to FIG. 2.

If the cookie exists, it is proof that browser 102 has been identified previously, and the measurement server 106 can request 1110 the browser's previously created unique ID. This allows the measurement server 106 to associate the consumption or viewing of the web resource with the browser 102 that is responsible.

In one embodiment, the measurement server 106 will randomly choose whether to survey the user associated with the unique browser 102, upon first recognizing a new unique browser (e.g., a new ID). In other embodiments the decision whether to survey can be made each time the client browser 102 accesses measured content 110. By randomly selecting the user, it helps ensure the sample of surveyed users is representative of all users of the web resource. The measurement server 106 can cause the measurement tag 108 to present a survey to the selected users. The surveys can collect data on audience demographics such as age, gender, location, ethnicity, income, profession or more custom data such as intent to purchase specific products. In one embodiment, the surveys can be customized for specific web resources, to provide the opportunity to ask different questions for viewers of different web content.

By encoding pages with measurement code, assigning each browser a unique ID, and randomly selecting from the group of browsers to survey, the present invention allows the measurement server 106 to produce statistically accurate measurements of audience composition.

In one embodiment, the surveyed users can be measured at any web site containing measured content 110, not just the site they were surveyed from. Once a user has provided survey data, the unique ID associated with the user can be recognized at any site with web content tagged with the measurement code 108. This allows the system to link behavior of an audience (such as an audience that visits web site A and web site B in the same month), with a report on the composition of the audience with that behavior

FIG. 1 illustrates an example of a system 100 implementing this invention. A user through his client browser 102 requests from a content (web) server 104 a web resource (page) that has been tagged 108 to be measured content 110. The supplied web resource 100, when loaded in the client browser 102, opens a connection to the measurement server 106. The measurement server 106 records each access for each individual measured content resource 110 that is accessed by a unique user in the audience measurement database 112. If the user has not been surveyed, the measurement server 106 will decide whether to survey the user. All survey data is stored in a user survey database 114 so that the survey data can be matched, via each client browser's unique ID, with the records of content accessed by the same browser ID. This provides a mechanism, through the audience measurement database 112, to report on total audience for each measured content resource, along with a composition based on the sample of users who accessed the resource and provided survey responses.

FIG. 2 illustrates in detail an example flow chart 200 of how users can be selected to be surveyed.

Step 202 indicates that a user contacts a site (e.g., server 104) and requests a content selection (e.g., content 110). Step 204 indicates that the user client software (e.g., browser 102) loads the measured content 110. Step 206 indicates that an embedded content tag 108 initiates a connection with measurement server 106.

Step 210 indicates that measurement server 106 requests a unique identifier or ID from the user client (e.g., browser 102). Step 212 represents a query as to whether the user (e.g., browser 102) has or returns a unique identifier. If the user (e.g., browser 102) has or returns a unique identifier, step 212 proceeds to step 214. If the user (e.g., browser 102) does not have or return a unique identifier, step 212 proceeds to step 216.

Step 214 represents a query as to whether the user associated with the browser 102 has been surveyed (i.e., recruited). Step 214 proceeds to step 218 if the user has been surveyed/recruited, and otherwise proceeds to step 220.

Step 218 indicates that the user survey data are included in a statistical summary of the content audience for a selected time period. Step 220 indicates that the measurement server 106 may uniquely identify the user as part of the content audience, but that additional information about the user is not included in a statistical summary of the survey data.

Step 216 indicates that the measurement server 106 assigns a new unique identifier to the user (i.e., browser 102). Step 222 represents a query as to whether the user is selected to be surveyed or recruited. Step 222 proceeds to step 224 if the user is selected to be surveyed/recruited, and otherwise proceeds to step 220. Step 224 indicates that a user recruitment survey is provided to the user (i.e., browser 102) and survey data provided by the user are stored in user survey database 114.

In an alternative embodiment, the present invention integrates web audience measurements with audience characteristics (e.g., demographics) that are obtained from a source other than random surveys that are dynamically presented to web site users. As one example, web audience measurements would be integrated with data from a pre-existing panel of computer users.

Such a panel could provide a random representation if the computer users had been recruited to be representative of a specific audience, for example through standard audience research techniques such as Random Digit Dialing (RDD) of telephone numbers or or direct mail. During recruitment of the panel, each computer user is surveyed for their audience data and assigned a unique panel member ID to be stored in a central database along with the user's audience data.

Each panel member then visits a site tagged with the measurement code to associate the panel member ID, along with it's associated audience data, with all future panel member visits to measured sites. In one implementation, the association can be achieved by having the panelist entering their unique ID manually through a web form. In another implementation, the association can be achieved more automatically by encoding the panel member ID in a custom URL that generated for each panel member. For example, each custom URL can include a web content network address that is combined with additional arguments comprising the panel member ID, and the custom URL can be executed in a browser or e-mail program to establish a network connection to the measured site and pass the ID to the system and allow a cookie to be set.

In accordance with the practices of persons skilled in the art of computer programming, the present invention is described above with reference to acts and symbolic representations of operations that are performed by various computer systems and devices. Such acts and operations are sometimes referred to as being computer-executed and may be associated with the operating system or the application program as appropriate. It will be appreciated that the acts and symbolically represented operations include the manipulation by a CPU of electrical signals representing data bits, which causes a resulting transformation or reduction of the electrical signal representation, and the maintenance of data bits at memory locations in a memory system to thereby reconfigure or otherwise alter the computer system operation, as well as other processing of signals. The memory locations where data bits are maintained are physical locations that have particular electrical, magnetic, or optical properties corresponding to the data bits.

Having described and illustrated the principles of our invention with reference to an illustrated embodiment, it will be recognized that the illustrated embodiment can be modified in arrangement and detail without departing from such principles. In view of the many possible embodiments to which the principles of our invention may be applied, it should be recognized that the detailed embodiments are illustrative only and should not be taken as limiting the scope of our invention. Rather, I claim as my invention all such embodiments as may come within the scope and spirit of the following claims and equivalents thereto.

1. In a computer network having one or more servers with server content that is accessible by plural client computers, a method of analyzing client computer use of server content, the method comprising:
providing to plural client computers server content in combination with measurement code, the server content and measurement code together representing measured content;
upon loading of the measured content by each client computer, automatically executing the measurement code on the client computer to establish a network connection between the client computer and a measurement server;
measuring at the measurement server audience size for the measured content based on data passed by the measurement code through the network connection to the measurement server;
establishing at the measurement server a unique identifier for each client computer that loads the measured content and establishes a network connection to the measurement server, the unique identifier being stored by the measurement server and passed to the client computer through the network connection to identify the client computer as a measured client;
initiating a survey of users of selected measured clients, which are a subset of the measured clients, to obtain survey data about the users, and transmitting the survey data along with the unique identifier for the selected measured clients to the measurement server to be stored in a database; and
estimating composition of an audience for server content by correlating the survey data from the selected measured clients with an audience being measured.

2. The method of claim 1 in which the measurement server randomly selects users of selected measured clients to be surveyed.

3. The method of claim 1 in which the measurement server selects users of selected measured clients to be surveyed and in which users of measured clients who are not selected by the measurement server to be surveyed upon an initial loading of the measured content are not selected by the measurement server to be surveyed upon any subsequent loading of the measured content.

4. The method of claim 1 in which the measurement server selects users of selected measured clients to be surveyed and in which the user of a selected measured client who does not complete a survey upon an initial loading of the measured content is surveyed again upon a subsequent loading of the measured content.

5. The method of claim 1 in which the server is a web server.

6. The method of claim 1 in which the measurement code is included in the server content.

7. The method of claim 1 in which the measurement code is provided to the client computers from a second server other than the one or more servers with server content based on server content being provided to the client computers.

8. The method of claim 1 in which completion of the survey by the user of a selected measured client in not required for the user to access the server content.

9. In a computer network having one or more servers with server content that is accessible by plural client computers, a method of analyzing client computer use of server content, the method comprising:
providing to plural client computers server content in combination with measurement code, the server content and measurement code together representing measured content;
upon loading of the measured content by each client computer, automatically executing the measurement code on the client computer to establish a network connection between the client computer and a measurement server;
measuring at the measurement server audience size for the measured content based on data passed by the measurement code through the network connection to the measurement server;
storing at the measurement server a unique identifier for each client computer that loads the measured content and establishes a network connection to the measurement server;
delivering the unique identifier to each client computer that loads the measured content and establishes a network connection to the measurement server to identify the client computer as a measured client;
obtaining a survey of users of selected measured clients, which are a subset of the measured clients, to obtain survey data about the users; and
estimating composition of an audience for server content by correlating the survey data from the selected measured clients with an audience being measured.

10. The method of claim 9 in which the users of the selected measured clients are a randomly selected panel of users.

11. The method of claim 9 in which the measurement server selects users of selected measured clients to be surveyed and in which users of measured clients who are not selected by the measurement server to be surveyed upon an initial loading of the measured content are not selected by the measurement server to be surveyed upon any subsequent loading of the measured content.

12. The method of claim 9 in which the measurement server selects users of selected measured clients to be surveyed and in which the user of a selected measured client who does not complete a survey upon an initial loading of the measured content is surveyed again upon a subsequent loading of the measured content.

13. The method of claim 9 in which the server is a web server.

14. The method of claim 9 in which the measurement code is included in the server content.

15. The method of claim 9 in which the measurement code is provided to the client computers from a second server other than the one or more servers with server content based on server content being provided to the client computers.

16. The method of claim 9 in which completion of the survey by the user of a selected measured client in not required for the user to access the server content.

17. In computer readable media, software for analyzing client computer use of server content accessible by plural client computers from one or more servers, comprising:
software for providing to plural client computers server content in combination with measurement code, the server content and measurement code together representing measured content;
software for automatically executing the measurement code on the client computer to establish a network connection between the client computer and a measurement server;
software for measuring at the measurement server audience size for the measured content based on data passed by the measurement code through the network connection to the measurement server;
software for establishing at the measurement server a unique identifier for each client computer that loads the measured content and establishes a network connection to the measurement server, the unique identifier being stored by the measurement server and passed to the client computer through the network connection to identify the client computer as a measured client;
software for initiating a survey of users of selected measured clients, which are a subset of the measured clients, to obtain survey data about the users, and transmitting the survey data along with the unique identifier for the selected measured clients to the measurement server to be stored in a database; and
software for estimating composition of an audience for server content by correlating the survey data from the selected measured clients with an audience being measured.

18. The media of claim 17 further comprising software for randomly selecting users of selected measured clients to be surveyed and in which users of measured clients who are not selected by the measurement server to be surveyed upon an initial loading of the measured content are not selected by the measurement server to be surveyed upon any subsequent loading of the measured content.

19. The media of claim 17 further comprising software for randomly selecting users of selected measured clients to be surveyed and in which the user of a selected measured client who does not complete a survey upon an initial loading of the measured content is surveyed again upon a subsequent loading of the measured content.
